(19) United States
(12) Patent Application Publication
(10) Pub. No.: US 2013/0038234 A1
(43) Pub. Date: Feb. 14, 2013

(54) DIMMING REGULATOR INCLUDING PROGRAMMABLE HYSTERETIC DOWN-CONVERTER FOR INCREASING DIMMING RESOLUTION OF SOLID STATE LIGHTING LOADS

(71) Applicants: Geert Willem Van Der Veen, Eindhoven (NL); Henricus Marius Joseph Maria Kahlman, Dongen (NL)

(72) Inventors: Geert Willem Van Der Veen, Eindhoven (NL); Henricus Marius Joseph Maria Kahlman, Dongen (NL)

(21) Appl. No.: 13/642,017

(22) PCT Filed: Apr. 22, 2011
(86) PCT No.: PCT/IB2011/051774

§ 371 Date: Oct. 18, 2012

Related U.S. Application Data
(60) Provisional application No. 61/329,577, filed on Apr. 30, 2010.

(51) Int. Cl. H05B 37/02

(52) U.S. Cl. 315/224

(57) ABSTRACT

A system providing deep dimming of a solid state lighting (SSL) load includes a hysteretic down-converter, a shunt switch, a controller and a comparator. The down-converter controls average current value and amplitude of ripple of SSL current using amplitude modulation (AM) dimming control. The shunt switch controls magnitude of the SSL current using pulse width modulation (PWM) dimming control. The controller generates first and second PWM signals for controlling upper and lower current levels at which the down-converter operates based on the SSL current and voltage across the SSL load, and generates a third PWM signal for controlling the shunt switch based on a dimming level load set by a dimmer. The comparator circuit compares first and second analog signals corresponding to the first and second PWM signals with the SSL current, and drives the down-converter in response to the comparison. The SSL current is based on both the AM dimming control and the PWM dimming control.

### TECHNICAL FIELD

The present invention is directed generally to dimming solid state lighting units. More particularly, various inventive methods and apparatus disclosed herein relate to selectively providing multiple dimming control methods to obtain large dimming resolution.

### BACKGROUND

Digital lighting technologies, i.e. illumination based on solid state or semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects.

Many lighting applications make use of dimmers. Conventional dimmers work well with incandescent (bulb and halogen) lamps. However, problems occur with other types of electronic lamps, including compact fluorescent lamp (CR), low voltage halogen lamps using electronic transformers and solid state lighting (SSL) lamps or units, such as LEDs and OLEDs, or other loads. Conventional dimmers typically chop a portion of each waveform (sine wave) of the mains voltage signal and pass the remainder of the waveform to the lighting fixture. A leading edge or forward-phase dimmer chops the leading edge of the voltage signal waveform. A trailing edge or reverse-phase dimmer chops the trailing edge of the voltage signal waveform.

Unlike incandescent and other resistive lighting devices which respond naturally without error to a chopped waveform produced by a dimmer, LED and other SSL units have still output an undesirably high amount of light at very low dimmer settings. Requirements for LED lighting used in theater and other entertainment and large space lighting, in particular, are more elaborate, especially with respect to the minimum achievable dimming level. A lighting unit used to light large spaces must have an extremely large dimming range or resolution, particularly to enable smooth start-up from a setting for emitting little to no light and to enable effective fading to nearly complete darkness. Conventionally, large dimming ranges are implemented using filament lamps, which generally provide slow and smooth dimming adjustments by nature. However, when conventional solid-state lighting (SSL) units, such as lighting units employing LED-based light sources, are used for theater and other large space lighting, the large dimming resolution required for smooth start-up cannot be achieved, since the minimum dimming level must be much lower than provided by conventional SSL drivers.

Hysteretic down-converters may be used in various SSL units. For example, a hysteretic down-converter may be used in combination with a shunt switch to create a pulse width modulation (PWM) dimmable current source of high resolution. However, as stated above, the low end dimming level is limited to a minimum of about 10 percent. The limited dimming level is attributed to a number of factors. For example, a flux feedback design measures luminous flux at the start of every PWM period, which requires a minimum pulse width. Also, stacked shunt switches require minimum pulse widths for level shifters to function properly. In addition, control is not suitable for adjusting amplitude of the LED current, and thus the frequency range of the down-converter becomes too large when amplitude modulation (AM) dimming is implemented.

Thus, there is a need in the art for an SSL system for lighting large spaces, capable of achieving very low dimmer levels.

### SUMMARY

The present disclosure is directed to inventive methods and apparatus for enabling high-resolution (or “deep”) dimming of an SSL unit, including during start-up of the SSL unit, for illuminating large spaces, e.g., such as studios and theaters. For example, a linear regulator is used to control current through the SSL during the start-up period and a switching regulator, e.g., including a PWM circuit, is used to control current through the SSL unit following the start-up period, to provide a smooth start-up and a high resolution during dimming.

Generally, according to one aspect, a system for providing deep dimming of a solid state lighting (SSL) load includes a hysteretic down-converter, a shunt switch and a controller. The hysteretic down-converter is connected between an input power source and the SSL load, the hysteretic down-converter being configured to control average current value and amplitude of ripple of an SSL current through the SSL load using amplitude modulation (AM) dimming control. The shunt switch is connected in parallel with the SSL load, the shunt switch being configured to control magnitude of the SSL current using pulse width modulation (PWM) dimming control. The controller is configured to generate first and second digital control signals for respectively controlling upper and lower current levels at which the hysteretic down-converter operates based on the SSL current and a voltage across the SSL load, and to generate a third digital control signal for controlling operation of the shunt switch based on a dimming level of the SSL load set by a dimmer. The SSL current is based on both the AM dimming control by the hysteretic down-converter and the PWM dimming control by the shunt switch at least when the dimming level is set below a lower threshold that is not achievable using either the AM dimming control or the PWM dimming control alone.

According to another aspect, a system for providing deep dimming of a light-emitting diode (LED) string includes a hysteretic down-converter connected between an input power source and the LED string, the hysteretic down-converter including a first switch operable to control amplitude and ripple of an LED current through the LED string. The system further includes a second switch connected in parallel with the LED string, the second switch being configured to control a pulse width modulation (PWM) of the LED current, and a controller configured to generate first and second PWM signals for respectively controlling upper and lower amplitude peaks of the LED current via the hysteretic down-converter, and to generate a third PWM signal for simultaneously controlling a duty cycle of the PWM of the LED current via the second switch based on a dimming level. The system further includes a comparator circuit configured to compare first and second analog signals corresponding to the first and second PWM signals with the LED current, and to drive the first switch in response to the comparison.

According to another aspect, a system is provided for deep dimming of an LED string operated by a hysteretic down-converter connected between the LED string and an input power source, and a shunt switch connected in parallel with the LED string. The includes a controller configured to generate first and second pulse width modulation (PWM) signals for respectively controlling upper and lower amplitude peaks of an LED current through the LED string via the hysteretic down-converter and to generate a third PWM signal for simultaneously controlling operation of the shunt switch to provide a duty cycle of the LED current through the LED string based on a dimming level, when the dimming level is set below a threshold that is otherwise not achievable by only controlling the upper and lower amplitude peaks of the LED current or the duty cycle of the LED current through the hysteretic down-converter and the shunt switch, respectively.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” or “luminaire” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as random access memory (RAM), programmable read-only memory (PROM), electrically programmable read-only memory (EPROM), electrically erasable and programmable read only memory (EEPROM), floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram illustrating a dimming regulating circuit for a solid state lighting unit, according to a representative embodiment.

FIG. 2 is a circuit diagram illustrating a dimming regulating circuit for a solid state lighting unit, according to a representative embodiment.

FIG. 3 is a graph showing current of a solid state lighting unit over time, according to a representative embodiment.

### DETAILED DESCRIPTION

As discussed above, Applicants have recognized and appreciated that it would be beneficial to have a solid state lighting system for large spaces, such as a theater lighting unit, that is controllable to have deep dimming ability.

In view of the foregoing, various embodiments and implementations of the present invention are directed to a dimming regulator having a fully software programmable hysteretic down-converter and a PWM shunt switch in an SSL lighting system with off-line flux feedback. A controller selectively implements AM dimming control and PWM dimming control simultaneously, via the hysteretic down-converter and the PWM shunt switch, in order to achieve low levels of dimming otherwise not attainable by either dimming control method used alone. Accordingly, the hysteretic down-converter and PWM shunt switch provide fully adjustable output current ripple, average output current, and PWM duty cycle. This enables full control over current to the LED lighting unit with the possibility to selectively combine AM and PWM dimming control, which enables extreme low dimming levels, e.g., down to about 0.02 percent per channel.

Further, optical measurements required for feedback, such as flux feedback, are only performed during start-up of the down-converter. The optical measurement values are used for feedback calculations during normal operation of the lighting source, during which no additional measurements need be performed. For example, the optical measurement values may be used to adjust the color coordinates and flux output of the various LED string colors at startup. The color coordinates and flux output may then be used during normal operation of the LED strings, so there are no dynamic adjustments during operation. The process may be referred to as a feed forward operation. The feedback implementation does not restrict PWM patterns or frequency, which would otherwise limit low end dimming levels.

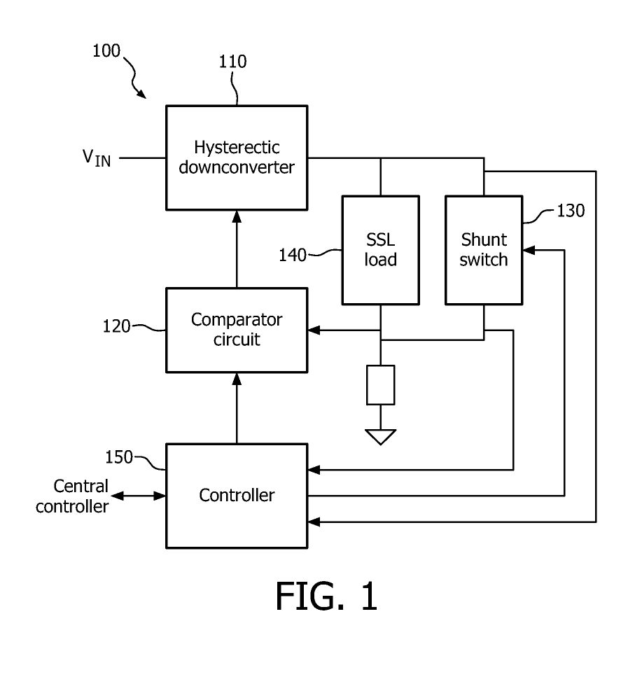

FIG. 1 is a block diagram illustrating a dimming regulating circuit for a solid state lighting unit, according to a representative embodiment.

Referring to FIG. 1, SSL dimming regulating circuit 100 includes hysteretic down-converter 110, comparator circuit 120, shunt switch circuit 130, SSL load 140 and controller 150. The hysteretic down-converter 110 is connected in series between a voltage source that provides supply voltage V_{IN} and the SSL load 140, which may be one or more LED units connected in series, for example. The hysteretic down-converter 110 is configured to control amplitude of the ripple of the current through the SSL load 140 using amplitude modulation (AM) dimming control, under control of the controller 150 and the comparator circuit 120.

In various embodiments, the controller 150 outputs first and second AM dimming control signals corresponding to high peaks (AM High) and low peaks (AM Low) in the ripple of the current through the SSL load 140. The comparator circuit 120 compares each of the first and second AM dimming control signals with the actual (average) current through the SSL load 140, and provides a gate driver signal to control operation of the hysteretic down-converter 110 in response to the comparison. As a result, the hysteretic down-converter 110 is able to adjust dynamically internal switching, which in turn adjusts the current output by the hysteretic down-converter 110 and passing through the SSL load 140, as needed, thus maintaining the AM dimming control within desired parameters set by the controller 110. The gate driver signal may be adjusted via the controller 150 to accommodate variations in dimming levels set or adjusted during normal operation. Thus, the hysteretic down-converter 110 is configured to control the ripple of the current through the SSL load 140 using AM dimming control, under control of the controller 150.

The shunt switch circuit 130 is connected parallel with the SSL load 140, and is selectively activated to generate a digital signal, such as a PWM signal, also for controlling the current through the SSL load 140. The duty cycle of the digital signal is adjustable by the controller 150 to accommodate variations in dimming levels during normal operation. That is, the controller 150 may dynamically adjust a gate drive signal that controls internal switching of the shunt switch circuit 130 to accommodate variations in dimming levels set or adjusted during normal operation. Thus, the shunt switch circuit 130 is configured to control the magnitude of the current through the SSL load 140 using PWM dimming control, under control of the controller 150.

The controller 150 may be a microcontroller, for example, dedicated to operation of one or more SSL loads, including the representative SSL load 140. The controller 150 may be connected to a central controller (not shown), for example, through an IIC or SPI control interface. The central controller may control the SSL dimming regulating circuit 100, as well as additional SSL dimming regulating circuits (not shown) having the same or similar configurations, in order to coordinate operations of the overall system. For example, the central controller may be a DMX controller, operating in conformance with the EIA-485 protocol, for stage lighting control.

In various embodiments, the controller 150 generates dimming setpoint information, or alternatively, receives dimming setpoint information generated externally, e.g., by the central controller. The dimming setpoint information indicates the dimming level to be applied by the controller based on various factors, including a dimmer setting and feedback from the SSL load 140. For example, the controller 150 and/or the central controller may receive luminous flux feedback and/or temperature measurements from the SSL load 140, and determine the dimming setpoint information based, at least in part, on this feedback. Also, in various embodiments, the controller 150 and/or the central controller may receive certain measurements only during start-up of the hysteretic down-converter 110, for example, so that there are no limitations of PWM duty cycles during normal operation of the SSL load 140. If the dimming setpoint is determined by the central controller, it may include feedback from additional SSL loads and/or dimming regulating circuits under its control.

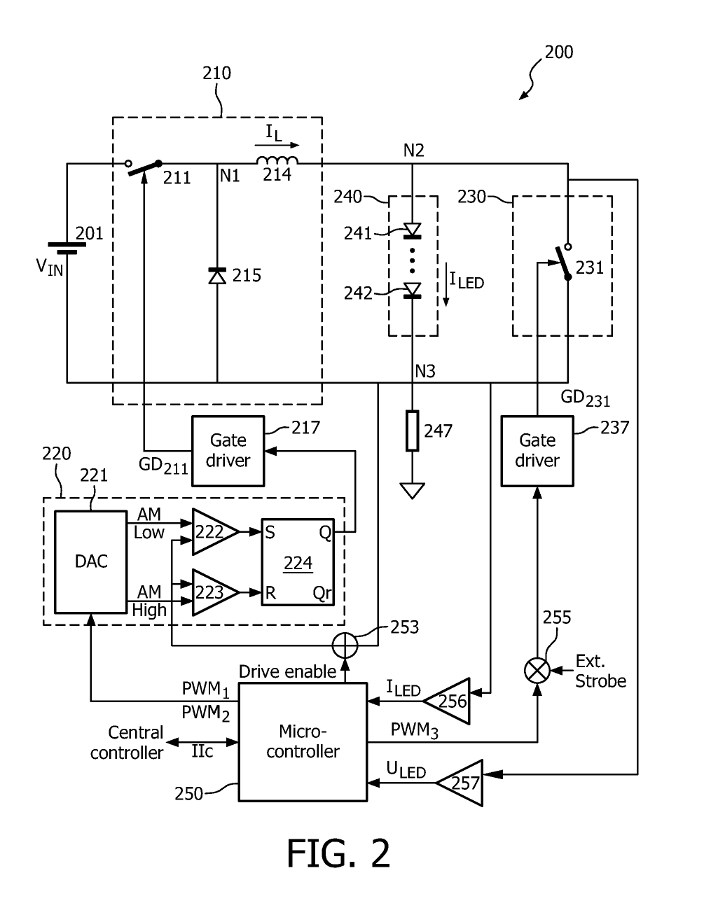

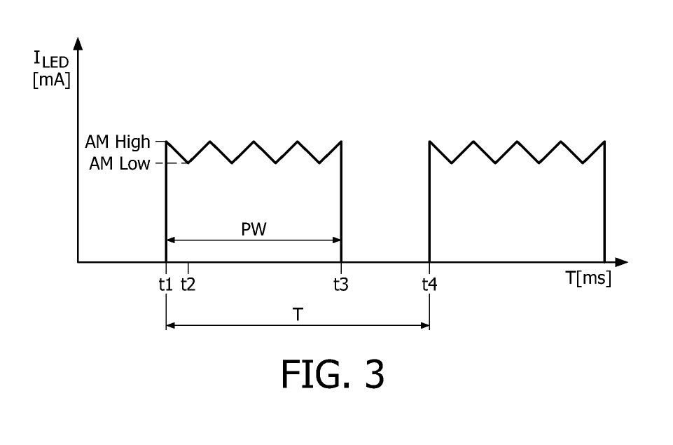

FIG. 2 is a circuit diagram illustrating a dimming regulating circuit for a solid state lighting unit, according to a representative embodiment. FIG. 3 is a graph showing current provided by a solid state lighting unit over time, according to a representative embodiment. In particular, FIG. 3 depicts current I_{LED} flowing through LED string 240 of FIG. 2, as discussed below. For the sake of clarity, FIG. 2 does not show various supporting circuitry, such as protection circuits, supply circuits, filtering circuits, and the like.

Referring to FIG. 2, SSL dimming regulating circuit 200 includes hysteretic down-converter 210, comparator circuit 220, shunt switch circuit 230, SSL load 240 and controller 250. The hysteretic down-converter 210 may be a synchronous buck converter, for example, and is connected in series between voltage source 201 and the LED string 240. The voltage source 201 provides supply voltage V_{IN} (e.g., about 24V or 48V) for powering the SSL dimming regulating circuit 200, at least in part. The LED string 240 includes one or more LEDs connected in series, indicated by representative LEDs 241 and 242. As discussed above with respect to the hysteretic down-converter 110, the hysteretic down-converter 210 is configured to control ripple of the LED current I_{LED} through the LED string 240 using AM dimming control, under control of the controller 250 and the comparator circuit 220, as discussed below.

In the depicted embodiment, the hysteretic down-converter 210 includes switch 211, inductor 214 and diode 215. The switch 211 is connected between the voltage source 201 and first node N1. The switch 211 is operated by gate driver 217, via driving signal GD₂₁₁, in response to a control signal from the comparator circuit 220, discussed below, in order to control inductor current I_{L} through the inductor 214 output by the hysteretic down-converter 210. The switch 211 may be a field-effect transistor (FET), such as such as a metal-oxide-semiconductor field-effect transistor (MOSFET) or a gallium arsenide field-effect transistor (GaAsFET), for example. Of course, various other types of switches and/or transistors may be implemented without departing from the scope of the present teachings. In various implementations, the hysteretic down-converter 210 may include one or more additional switches operated by the gate driver 217, which may be used to control additional output currents. Diode D215 may be replaced with a switch, for example, to increase the efficiency.

The inductor 214 connected between first node N1 and second node N2, which corresponds to inputs of the LED string 240 and the shunt switch circuit 230. The diode 215 has an anode connected to third node N3 and a cathode connected to first node N1, thus enabling inductor current I_{L} to continue to flow through the inductor 214 when the switch 211 is open (e.g., the FET is off), creating a ripple effect. The hysteretic down-converter 210 may also include a filter capacitor (not shown) between node N2 and node N3. FIG. 3 depicts an illustrative LED current I_{LED} having ripple with high and low amplitude peaks responsive to operation of the switch 211, indicated by AM High and AM Low at times t1 and t2.

The shunt switch circuit 230 includes a switch 231 connected parallel with the LED string 240, and is selectively activated to generate a PWM signal for further controlling the current I_{LED} through the LED string 240. The switch 231 is operated by gate driver 237, via driving signal GD₂₃₁, in response to a control signal from the controller 250, discussed below. Generally, the driving signal GD₂₃₁ has high and low signal levels, e.g., corresponding to high and low signal levels of third PWM control signal PWM₃, discussed below, where the high signal level causes the switch 231 to close (e.g., turning on the corresponding transistor) and the low level causes the switch 231 to open (e.g., turning off the corresponding transistor). The switch 231 may be an FET, such as a MOSFET or a GaAsFET, for example. Of course, various other types of switches and/or transistors may be implemented without departing from the scope of the present teachings.

Operation of the switch 231 therefore provides a duty cycle of a PWM signal, which drives the LED string 240 in accordance with a dimming level set by the dimmer (not shown). In other words, the duty cycle determines the magnitude of the LED current I_{LED} through the LED string 240. For example, the PWM signal has a high duty cycle in response to a high dimmer setting (e.g., providing a small amount of dimming), and the PWM signal has a low duty cycle in response to a low dimmer sitting (e.g., providing a large amount of dimming), as determined by the controller 250 and/or the central controller. FIG. 3 depicts an illustrative LED current I_{LED} having a PWM signal responsive to operation of the switch 231, where the pulse width PW occurs between times t1 and t3, and the period T of the duty cycle occurs between times t1 and t4.

Of course, the duty cycle of the PWM signal may vary, depending on the dimming setpoint received or determined by the controller 250. For example, the second switch 241 generates a PWM signal having longer pulse widths (longer duty cycles) in response to higher dimming setpoints, and shorter pulse widths (shorter duty cycles) in response to lower dimming setpoints. Thus, LED current I_{LED} increases through the LED string 240 in response to larger pulse widths resulting in a higher level of light output, and decreases in response to short pulse widths resulting in a lower level of light output.

The controller 250 controls the hysteretic down-converter 210, the comparator circuit 220, and the shunt switch circuit 220 through selective activation and control of various control signals. Also, the controller 250 may, in turn, operate under control of a central controller (not shown) through a control interface, such as an IIC or SPI control interface, or the like, as discussed above with respect to controller 150.

In the depicted embodiment, the controller 250 outputs first and second PWM control signals PWM₁ and PWM₂ to the comparator circuit 220, and outputs third PWM control signal PWM₃ to the gate driver 237 of the shunt switch circuit 230. The first and second PWM control signals PWM₁ and PWM₂ determine the average current value and the amplitude of the ripple of the current provided to the LED string 240 by the hysteretic down-converter 210. In other words, the first and second PWM control signals PWM₁ and PWM₂ are used to set the AM Low and AM High signals for respectively determining the low and high current levels at which the hysteretic down-converter 210 operates, as well as the low and high current peaks of the ripple in the LED current I_{LED}. The third PWM control signal PWM₃ is used to set the duty cycle of the PWM signal generated by operation of the shunt switch 231, which determines the magnitude of the LED current I_{LED} through the LED. In various embodiments, the first and second PWM signals PWM₁ and PWM₂ have relatively high frequencies (e.g., between about 20 kHz and about 100 kHz), and the third PWM signal PWM₃ has a relatively low frequency (e.g., between about 1 kHz and about 20 kHz). Also, the third PWM control signal PWM₃ may be mixed with an external strobe signal by multiplexer 255, for example, in order to synchronize the gate driver 237 with gate drivers of other shunt switches and corresponding LED strings (e.g., which may be operating simultaneously with the SSL dimming regulating circuit 200 under control of the central controller).

The controller 250 also receives various feedback signals in order to determine and generate the first through third PWM control signals PWM₁-PWM₃. In the depicted embodiment, the controller 250 receives the LED current I_{LED} measured from sense resistor 247 through operational amplifier 256, and receives LED voltage U_{LED} from the second node N2 through operational amplifier 257. The operational amplifiers 256 and 257 provide signal conditioning, for example, and may be implemented by various alternative means, such as voltage dividers, as would be apparent to one of ordinary skill in the art. Also, in various embodiments, the controller 250 generates a drive enable signal that is mixed by adder 253 with the LED current I_{LED} from the LED string 240 in order to shut down and/or enable the hysteretic down-converter 210.

The controller 250 may be constructed of any combination of hardware, firmware or software architectures, as discussed above, without departing from the scope of the present teachings. Also, in various embodiments, the controller 250 may include its own memory (e.g., nonvolatile memory) for storing software/firmware executable code that allows it to perform the various functions of the SSL dimming regulating circuit 200. For example, the executable code may include code for receiving feedback signals, for calculating or receiving dimming setpoints, for determining and generating first through third PWM control signals PWM₁, PWM₂ and/or PWM₃, and the like. Alternatively, the executable code may be stored in designated memory locations within separate ROM and/or RAM. The ROM may include any number, type and combination of tangible computer readable storage media, such as PROM, EPROM, EEPROM, and the like. In various embodiments, the controller 250 may implemented as a microcontroller, ASIC, FPGA, microprocessor, such as an ARM Cortex M3 microcontroller, or the like.

In the depicted embodiment, the comparator circuit 220 includes digital-to-analog converter (DAC) 221, first and second comparators 222 and 223, and flip-flop 224. In the depicted embodiment, the first and second comparators 222 and 233 may be implemented by operational amplifiers, and the flip-flop 224 may be implemented by a reset-set (RS) flip-flop, although other types of comparators and/or flip-flops (or latches) may be incorporated, as would be apparent to one of ordinary skill in the art. The DAC 221 receives the digital first and second PWM control signals PWM₁ and PWM₂ from the controller 250, and outputs corresponding analog signals AM Low and AM High, respectively. In alternative embodiments, the DAC 221 may be incorporated within the controller 250, in which case analog AM Low and AM High signals corresponding to the first and second PWM control signals PWM₁ and PWM₂ (as opposed to the first and second PWM control signals PWM₁ and PWM₂ themselves) are output by the controller 250.

The analog signals AM Low and AM High are compared to the LED current I_{LED}, respectively, and a digital control signal is generated based on these comparisons to drive the gate driver 217 of the hysteretic converter 210, thus affecting operation of the switch 211 and thus the inductor current I_{L}. Generally, the gate driver 217 provides a driving signal GD₂₁₁ that has high and low signal levels, where the high signal level causes the switch 211 to close (e.g., turn on the corresponding transistor) and the low level causes the switch 211 to open (e.g., turn off the corresponding transistor).

For example, in various embodiments, the AM Low signal is input to the negative input of the first comparator 222 and the LED current I_{LED} is input to the positive input of the first comparator 222, and an AM Low comparison signal is output by the first comparator 222 to the set input S of the flip-flop 224. Meanwhile, the AM High signal is input to the negative input of the second comparator 223 and the LED current I_{LED} is input to the positive input of the second comparator 223, and an AM High comparison signal is output by the second comparator 223 to the reset input R of the flip-flop 224. Generally, when the AM Low comparison signal transitions to a high value, indicating that the LED current I_{LED} has reached the minimum value of the ripple, the set input S of the flip-flop 224 is engaged, forcing the digital control signal output from the Q output high. When the AM High comparison signal transitions to a high value, indicating that the LED current I_{LED} has reached the maximum peak current of the ripple, the reset input R of the flip-flip 224 is engaged and the Q output is forced low, disconnecting the input voltage source and enabling the current to free-wheel through diode 215, thus reducing the current.

For example, when the LED current I_{LED} is either less than the AM Low signal or greater than the AM High signal, the gate driver 217 causes the switch 211 open (e.g., the corresponding transistor is turned off), temporarily removing the voltage source 201 from the LED string 240, resulting in a slow reduction of the LED current I_{LED} through the LED string 240 via the diode 215, as shown by a ripple effect of the LED current I_{LED} beginning at times t1 and t4 of FIG. 3. The ripple effect may occur at a frequency of about 100 kHz, for example, and the difference between the high peaks (e.g., at time t1) and the low peaks (e.g., at time t2) of the ripple effect may be about 100 mA, for example. The switch 211 is cycled between closed and opened states at different intervals, depending on desired AM Low, AM High and frequency parameters of the ripple, throughout normal operation of the LED string 230.

In various embodiments, the hysteretic converter 210 may include another switch. In this case, the flip-flop 224 may be configured to simultaneously control the other switch via the gate driver 217 using a digital control signal output from the Qn output.

Operation of the SSL dimming regulating circuit 200 is now described with reference to FIGS. 2 and 3. In an embodiment, the controller 250 receives dimming set point information from the central controller, for example, through an IIC control interface. The dimming set point information may be determined based on user inputs and/or feedback from the circuit, and generally indicates a required average current value (e.g., as a percentage of the maximum to reflect the dimming level). The user inputs may be received by the central controller through a DMX interface, for example, in a stage or theater setting. The feedback may include luminous flux feedback information and temperature information, for example, obtained through corresponding sensors. In various embodiments, the central controller may control multiple SSL dimming systems, like dimming regulating circuit 200, through a comprehensive control panel. The various dimming systems may be set by the central controller to different dimmer levels to achieve desired lighting effects, including variations in brightness and color. In alternative embodiments, as discussed above, the controller 250 may generate the dimming set point itself based on user inputs and/or feedback that it receives directly or through the central controller, without departing from the scope of the present teachings.

The controller 250 calculates the values of the first and second PWM control signals PWM₁ and PWM₂ for controlling operation of the hysteretic down-converter 210 and third PWM control signal PWM₃ to for controlling operation of the shunt switch circuit 230, based on the dimming set point information combined with measurements in the circuit and a model of the hysteretic converter 210 in software. The measurements may include, for example, the LED voltage U_{LED} and the LED current I_{LED} received from the LED string 240, as discussed above. In various embodiments, the measurements may also include measured input voltage V_{IN} and/or temperature of the LED string 240 for additional accuracy.

The control signal values may be calculated following standard design formulas for controlling down-converters. For example, a continuous mode step down-converter may be used, where the voltage V_{L} across the inductor 214 is indicated by Formula (1), below:

$${V}_{L} = L \frac{d {I}_{L}}{d t} \qquad ( 1 )$$

The values of the inductor current I_{L} when the switch 211 of the hysteretic converter 210 is closed (on) and open (off) determine the ripple and the average value of the LED current I_{LED}. The inductor current I_{L} when the switch 211 is on (Iₒₙ) is shown by Formula (2) and the inductor current I_{L} when the switch 211 is off (I_{Loff}) is shown by Formula (3), below:

$$\begin{matrix}Δ {I}_{{L}_{on}} = {\int }_{0}^{{t}_{on}} \frac{{V}_{L}}{L} d t = \frac{( {V}_{i} - {V}_{o} ) \cdot {t}_{on}}{L} & ( 2 ) \\ Δ {I}_{{L}_{off}} = {\int }_{0}^{{t}_{off}} \frac{{V}_{L}}{L} d t = - \frac{{V}_{o} \cdot {t}_{off}}{L} & ( 3 )\end{matrix}$$

Of course, the control signal values may be calculated using various other design formulas for controlling down-converters, without departing from the scope of the present teachings.

As discussed above, the first and second PWM control signals PWM₁ and PWM₂ are used for determining upper and lower peaks (AM Low and AM High) of the current ripple provided by the hysteretic down-converter 210 according to AM dimming control. The third PWM control signal PWM₃ is used for determining a duty cycle at which the shunt switch circuit 230 will be operated according to PWM dimming control. The controller 250 is therefore able to simultaneously implement AM dimming control and PWM dimming control of the LED string 240. By combining AM dimming control and PWM dimming control, the controller 250 is able to increase the dimming range over the dimming ranges achievable by either AM dimming control or PWM dimming control, alone. In other words, by combining the AM and PWM dimming control, the low end level of light output by the LED string 240 may be dimmed below a threshold that would be otherwise achievable using solely the AM dimming control or the PWM dimming control.

For example, in the configuration depicted in FIG. 2, the dimming range that can be achieved with only AM dimming control is about 100 percent (no dimming) to about 4 percent (minimum dimming), while the dimming range that can be achieved with only PWM dimming control is about 100 percent to about 0.5 percent. However, by combining the AM dimming control and the PWM dimming control in accordance with various embodiments, the dimming range of the SSL dimming regulating circuit 200 is about 100 percent to about 0.02 percent.

According to various embodiments, the AM and PWM dimming control may be flexibly implemented for tuning to application specific requirements. For example, the controller 250 may be programmed to perform only PWM dimming control for dimming setpoints between about 100 percent to about 1 percent, and to perform combined AM and PWM dimming control for dimming setpoints lower than about 1 percent, extending the dimming range down to about 0.02 percent. Similarly, the controller 250 may be programmed to perform only AM dimming control for dimming setpoints between about 100 percent to about 4 percent, and to perform combined AM and PWM dimming control for dimming setpoints lower than about 4 percent, extending the dimming range down to about 0.02 percent. Likewise, AM dimming control or PWM dimming control may be selectively performed only during times when more refined levels of lighting control of the LED string 240 are needed.

The upper and lower peaks of the current ripple determine the average output current (e.g., inductor current I_{L}) of the hysteretic down-converter 210, as well as the average LED current I_{LED} through the LED string 240. In an embodiment, the controller 250 further executes an optimizing algorithm, which calculates the optimum upper and lower current peaks at which the ripple is minimized, and ensures that the resulting operating frequency is within a safe operating area of the hysteretic down-converter 210. For example, the safe operating area may be limited by audible frequencies on the low end and by a maximum frequency at which the controller 250 and the switches 211 and 231 can safely operate on the high end.

According to various embodiments, the SSL dimming regulating circuit 200 is about to perform extreme deep dimming. Also, there is full control of the operating frequency, so that audible noise, due to frequencies lower than about 20 kHz when the shunt switch 231 is closed, may be eliminated. Relatively high frequency (e.g., greater than about 15 kHz) PWM duty cycle of the shunt switch 231 is possible, with no audible noise, visible flicker or camera interference. Also, the LED current I_{LED} may be precisely controlled, independent of the input voltage V_{IN} and the LED forward voltage.

Of course, the values of the various components of FIG. 2, such as the input voltage V_{IN}, the inductor 214, and the resistor 247, may vary to provide unique benefits for any particular situation or to meet application specific design requirements of various implementations, as would be apparent to one skilled in the art.

Various embodiments may be implemented to power an SSL light engine designed for studios, theater, architecture lighting (city beautification), shops and hospitality (e.g., hotels, restaurants), or other large or open spaces. Accordingly, colored light may be used, particularly where scene setting and atmosphere creation are important. Conventionally, this would be accomplished by cumbersomely combining white light sources with colored filters. In contrast to these conventional systems, systems with multicolored LEDs, implemented in accordance with the embodiments described herein, can be used to generate the colors at various levels of dimming without filters. This has an efficiency advantage and, more importantly, colors can be changed by the electronics, so there is no need to change filters and all colors are always available. Having electronically regulated colors enables use of various automatic programming methods. Also, because there are no filters, supply and maintenance are simplified. For example, there are no filters to be removed and replaced, and colors are consistently provided since there are no replacement filters to introduce color variations.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. Also, any reference numerals or other characters, appearing between parentheses in the claims, are provided merely for convenience and are not intended to limit the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A system for providing deep dimming of a solid state lighting (SSL) load, the system comprising:
a hysteretic down-converter connected between an input power source and the SSL load, the hysteretic down-converter being configured to control average current value and amplitude of ripple of an SSL current through the SSL load using amplitude modulation (AM) dimming control;
a shunt switch connected in parallel with the SSL load, the shunt switch being configured to control magnitude of the SSL current using pulse width modulation (PWM) dimming control; and
a controller configured to generate first and second digital control signals for respectively controlling upper and lower current levels at which the hysteretic down-converter operates based on the SSL current and a voltage across the SSL load, and to generate a third digital control signal for controlling operation of the shunt switch based on a dimming level of the SSL load set by a dimmer,
wherein the SSL current is based on both the AM dimming control by the hysteretic down-converter and the PWM dimming control by the shunt switch at least when the dimming level is set below a lower threshold that is not achievable using either the AM dimming control or the PWM dimming control alone.

2. The system of claim 1, further comprising:
a comparator circuit configured to compare first and second analog signals corresponding to the first and second digital control signals with the SSL current, and to drive the hysteretic down-converter in response to the comparison.

3. The system of claim 2, wherein the comparator circuit comprises:
a digital to analog converter configured to convert the first and second digital control signals into the corresponding first and second analog signals;
a first comparator configured to compare the first analog signal with the SSL current from the SSL load;
a second comparator configured to compare the second analog signal with the SSL current from the SSL load; and
a gate driver configured to selectively activate at least one transistor of the hysteretic down-converter in response to outputs from the first and second comparators.

4. The system of claim 2, wherein the first and second digital control signals determine the average current value and the amplitude of the ripple of the current provided to the SSL load by the hysteretic down-converter.

5. The system of claim 4, wherein the first and second digital control signals optimize the ripple of the average output current provided by the hysteretic down-converter.

6. The system of claim 4, wherein a duty cycle of the PWM control by the shunt switch, the average output current by provided by the hysteretic down-converter and the ripple of the average output current provided by the hysteretic down-converter are fully adjustable.

7. The system of claim 1, wherein the controller receives dimming setpoint information from a central controller, indicating the dimming level set by the dimmer.

8. The system of claim 7, wherein the central controller determines the dimming setpoint information is based on at least one of luminous flux feedback from the SSL load, temperature and user input.

9. The system of claim 1, wherein the controller generates dimming setpoint information indicating the dimming level set by the dimmer.

10. The system of claim 9, wherein the controller generates the dimming setpoint information is based on at least one of luminous flux feedback from the SSL load, temperature and user input.

11. The system of claim 1, further comprising:
a multiplexer configured to multiplex the third digital control signal and an external strobe signal to synchronize operation of the shunt switch with at least one other shunt switch.

12. The system of claim 2, wherein the first, second and third digital control signals comprise first, second and third PWM signals, respectively.

13. The system of claim 12, wherein controller comprises a software model of the hysteretic down-converter and generates the first and second PWM signals by applying at least the SSL current and the voltage across the SSL load to the software model.

14. The system of claim 13, wherein controller generates the first and second PWM signals by further applying at least one of an input voltage and a temperature to the software model.

15. The system of claim 1, wherein the controller generates the first and second digital control signals further based on a voltage of the input power source.

16. The system of claim 2, wherein the hysteretic down-converter comprises a switch and an inductor connected in series between input power source and the SSL load, and a diode connected between a ground voltage and the inductor.

17. The system of claim 16, wherein the amplitude and ripple of the SSL current through the SSL load is adjustable through operation of the switch in the hysteretic down-converter.

18. A system for providing deep dimming of a light-emitting diode (LED) string, the system comprising:
a hysteretic down-converter connected between an input power source and the LED string, the hysteretic down-converter including a first switch operable to control amplitude and ripple of an LED current through the LED string;
a second switch connected in parallel with the LED string, the second switch being configured to control a pulse width modulation (PWM) of the LED current;
a controller configured to generate first and second PWM signals for respectively controlling upper and lower amplitude peaks of the LED current via the hysteretic down-converter, and to generate a third PWM signal for simultaneously controlling a duty cycle of the PWM of the LED current via the second switch based on a dimming level; and
a comparator circuit configured to compare first and second analog signals corresponding to the first and second PWM signals with the LED current, and to drive the first switch in response to the comparison.

19. The system of claim 18, wherein the comparator circuit comprises:
a digital to analog converter configured to convert the first and second PWM signals into the corresponding first and second analog signals;
a first comparator configured to compare the first analog signal with the LED current from the LED string;
a second comparator configured to compare the second analog signal with the LED current from the LED string; and
a gate driver configured to selectively activate at least one transistor of the hysteretic down-converter in response to outputs from the first and second comparators.

20. A system for providing deep dimming of a light-emitting diode (LED) string operated by a hysteretic down-converter connected between the LED string and an input power source, and a shunt switch connected in parallel with the LED string, the system comprising:
a controller configured to generate first and second pulse width modulation (PWM) signals for respectively controlling upper and lower amplitude peaks of an LED current through the LED string via the hysteretic down-converter and to generate a third PWM signal for simultaneously controlling operation of the shunt switch to provide a duty cycle of the LED current through the LED string based on a dimming level, when the dimming level is set below a threshold that is otherwise not achievable by only controlling the upper and lower amplitude peaks of the LED current or the duty cycle of the LED current through the hysteretic down-converter and the shunt switch, respectively.
